(19) United States
(12) Patent Application Publication
(10) Pub. No.: US 2023/0150573 A1
(43) Pub. Date: May 18, 2023

(54) HYDRAULIC AUXILIARY AXLE STEERING CONTROL SYSTEM

(71) Applicant: SEWON E&C Co., Ltd., Changwon-si (KR)

(72) Inventors: Sung Min HAN, Changwon-si (KR); Jung Woo SHIN, Changwon-si (KR); Chung Mok YOO, Changwon-si (KR); Ji Woong KIM, Changwon-si (KR); Min Seong KIM, Changwon-si (KR)

(21) Appl. No.: 17/845,085

(22) Filed: Jun. 21, 2022

(30) Foreign Application Priority Data
Nov. 16, 2021 (KR) 10-2021-0157447

(51) Int. Cl. B62D 6/00; B62D 5/14; B62D 5/06

(52) U.S. Cl. CPC B62D 6/002; B62D 5/14; B62D 5/064; B62D 6/001

(57) ABSTRACT

A hydraulic auxiliary axle steering control system is provided. In detail, there is provided a hydraulic auxiliary axle steering control system that can perform quick, precise, and safe control by changing an auxiliary axle steering control angle in accordance with a vehicle speed to problems with instability of driving, wear of tires, and a turning radius when a vehicle is driven at a low speed.

### CROSS REFERENCE TO RELATED APPLICATION

The present application claims priority to Korean Patent Application No. 10-2021-0157447, filed Nov. 16, 2021, the entire contents of which is incorporated herein for all purposes by this reference.

### BACKGROUND OF THE INVENTION

### Field of the Invention

The present disclosure relates to a hydraulic auxiliary axle steering control system and, more particularly, a hydraulic auxiliary axle steering control system that can perform quick, precise, and safe control by changing an auxiliary axle steering control angle in accordance with a vehicle speed to remove problems with instability of driving, wear of tires, and a turning radius when a vehicle is driven at a low speed.

### Description of the Related Art

A commercial vehicle means a vehicle manufactured to transport many people or goods or to perform work for specific purposes, and there are various commercial vehicles such as middle-sized and large-sized buses, a truck, a dump truck, a mixer, a fire truck, and a crane.

An electrohydraulic auxiliary axle steering system for middle-sized and large-sized commercial vehicles, which is provided for an auxiliary axle mounted at the rear portion of middle-sized and large-sized commercial vehicles, is a system for increasing driving and steering stability of a vehicle and improving the steering function by preventing excess of axial load due to overloading, and over-steering and an increase of braking distance that may be generated during driving.

A steering control system actively steers rear wheels in correspondence to front wheel steering through a steering apparatus attached to the auxiliary axle of large-sized trucks, thereby improving driving safety of a vehicle including improvement of the steering ability for the entire vehicle and reduction of a turning radius.

Korean Patent Application Publication No. 10-2019-0004551 relates to an apparatus for controlling a steering angle of a lane keeping assist system. The lane keeping assist system finds out the position of a vehicle in a lane using a sensor that senses lanes, calculates a required steering angle to move the vehicle at the center of the lane, calculates steering torque to follow the required steering angle, and controls steering of the vehicle in accordance with the calculated steering torque.

However, there is a problem that when a road is transversely inclined or a steering system variance is generated, a difference is generated between rotation torque and return torque of the steering system and a steering angle is generated in the direction of large rotation torque, so a vehicle is biased.

In particular, a lane keeping assist system assists a driver to keep a lane, but a driver may feel inconvenience when the system strongly controls steering to follow a lane. Accordingly, at present, a lane keeping assist system is set to weakly control steering by performing steering control in a direction in which a driver minimally feels inconvenience, so the system is easily influenced by vehicle variance and external disturbance. Further, when a road is transversely inclined or a steering system variance is generated, a vehicle may be controlled in a biased state.

Accordingly, the apparatus for controlling a steering angle of a lane keeping assist system of the patent described above includes: a steering angle gain variation determination unit that determines an increase or a decrease of a steering gain variation speed on the basis of a steering angle error value; a steering angle gain calculation unit that calculates a steering angle gain according to the steering angle variation speed; a steering angle gain adjustment unit that calculates a final gain reflecting intention of a driver to the steering angle gain; and a steering torque calculation unit that calculates steering angle torque using the final gain.

The steering angle gain variation determination unit may include a variation speed determination unit that calculates the steering angle error value and determines an increase or a decrease of the steering angle gain variation speed by comparing the steering angle error value with a predetermined reference value; and a maximum gain determination unit that determines a maximum gain when it is determined that the steering angle gain variation speed has increased.

Further, Korean Patent No. 10-1316838 relates to a steering angle control method for an electric steering apparatus. In more detail, the method includes: a vehicle speed sensor step of sensing a vehicle speed and transmitting a vehicle sensing signal; a torque sensor step of sensing steering torque and transmitting a torque sensing signal; a steering angle sensor step of sensing and transmitting a steering angle input by a driver and sensing and transmitting reverse input from the outside of a vehicle; a motor rotation and deceleration step of receiving and calculating signals from the vehicle speed sensor, the torque sensor, and the steering angle sensor and rotating a motor in accordance with the result of calculation; and an adjustment step of changing a steering stroke in accordance with an axle stroke. The adjustment step includes; a step of calculating a gap according to the stroke of an axle and generating an optimized variable rack stroke table for each axle stroke; a step of fixing the rack stroke when the vehicle speed is a predetermined level or higher; and a step of determining an optimal rack stroke by measuring the stroke of the axle through a height sensor and recognizing an axle stroke and a steering angle. A control method is simply added without adding specific hardware or control unit to the electric steering apparatus, whereby it is possible to change the rack stroke for a vehicle posture and it is also possible to decrease a minimum turning radius by increasing the steering angle even under a general steering condition.

Further, Korean Patent No. 10-2202522 relates to an apparatus, a method, and a computer program that provide a steering control signal to a vehicle and the method includes a step of obtaining information of the rotation angle of a steering wheel of a vehicle 100 (110). The method further includes a step of obtaining information of a driving direction of the vehicle 100 (120). The information of a driving direction shows whether the vehicle 100 is configured to move forward or whether the vehicle 100 is configured to move backward. The method further includes a step of determining a steering angle for the vehicle on the basis of the rotation angle of the steering wheel and the information of the driving direction of the vehicle 100 (130). When the vehicle 100 is configured to move backward, the steering angle is adjusted on the basis of an adjustment function. The method further includes a step of providing a steering angle control signal on the basis of the steering angle determined in step 130 (140).

Further, Korean Patent No. 10-1694718 relates to a steering angle control system. The steering angle control system for a vehicle includes: a worm gear unit that receives torque when a steering apparatus of the vehicle is rotated; a gear housing in which the worm gear unit is mounted; a magnet member that is coupled to the worm gear unit; a Hall sensor that measures a rotation amount of the magnet member and outputting a voltage corresponding to the rotation amount; a control unit that receives the voltage output from the Hall sensor when the vehicle is started, and operates an actuator, which rotates a steering shaft installed to steer the vehicle, forward or backward so that steering wheels of the vehicle are positioned in the forward direction when the output voltage comes out of the range of a reference voltage stored in advance; and a control unit holder that has an accommodation portion therein for accommodating the control unit and is coupled to the outer surface of the gear housing. The worm gear unit includes: a work-actuating shaft that is inserted in a through-hole formed through both sides of the gear housing through two shaft bearings, has one side mounted in the gear housing by a first shaft bearing and an another side mounted in the gear housing by a second shaft bearing, has screw-shaped teeth at the middle portion, and rotates by a predetermined value to correspond to the rotation amount of the actuator; and a work gear that is inserted in a seat groove recessed inward on the front of the gear housing, has a plurality of teeth on the outer surface to engage with the worm-actuating shaft, and rotates by a predetermined amount in accordance with the number of revolutions of the work-actuating shaft. The through-hole and the seat groove are connected to each other such that the worm-actuating shaft and the worm gear are engaged. The control unit includes: a printed circuit board on which a circuit is formed and the Hall sensor is installed, that is accommodated in an accommodation portion of the control unit holder, and is disposed on the outer surface of the gear housing perpendicularly to the rotary shaft of the worm gear; and a controller that is seated on the printed circuit board, receives the voltage, and drives the actuator.

### PRIOR ART DOCUMENT

### Patent Document

(Patent Document 1) (0001) Korean Patent Application Publication No. 10-2019-0004551, titled “Apparatus for controlling a steering angle of a lane keeping assist system”.

(Patent Document 2) (0002) Korean Patent No. 10-1316838, titled “MDPS steering apparatus steering angle control method”

(Patent Document 3) (0003) Korean Patent No. 10-2202522, titled “Apparatus, method, and computer program for providing a steering angle control signal for a vehicle”

(Patent Document 4) (0004) Korean Patent No. 10-1694718, titled “Steering angle controller”

### SUMMARY OF THE INVENTION

FIG. 1 shows an existing hydraulic auxiliary axle steering control system, and the main components and the function thereof in the system are as follows.

The hydraulic auxiliary axle steering control system includes: a front-wheel angle sensor 200 installed on a front wheel or a vehicle and sensing operation for steering by a driver; an Electrical Control Unit (ECU) 110 receiving a front-wheel angle from the front-wheel angle sensor 200 and calculating a steering value of an auxiliary axle using a program; a motor 120 being driven by a control signal from the ECU 110; a hydraulic pump generating hydraulic pressure; a double rod cylinder 440 being operated by the hydraulic pressure generated by the hydraulic pump 130; and an auxiliary axle sensor 300 disposed on the auxiliary axle and sensing a steering angle of the auxiliary axle, in which the ECU 110 controls the hydraulic auxiliary axle steering control system while receiving feedback about the steering angle of the auxiliary axle from the auxiliary axle sensor 300.

However, since the existing hydraulic auxiliary axle steering control system is a control system based on steering of front wheels, steering the auxiliary axle based on front-wheel steering when a vehicle is driven at a low speed is not precise, so there is a problem that driving is unstable, tires are worn a lot, and turning in a narrow space is difficult.

Accordingly, it is possible to secure stability of a vehicle by changing the angles of rear wheels in accordance with variation of the angle of front wheel when a commercial vehicle is steered and by changing the relation of the front-wheel angle and the rear-wheel angle in accordance with a vehicle speed.

In order to achieve the objectives of the present disclosure, a hydraulic auxiliary axle steering control system includes: a sensor configured to steering of front wheels and a vehicle speed; an ECU configured to calculate and control a steering value of the auxiliary axle in accordance with the vehicle speed and steering of the front wheels; a motor and a hydraulic pump being able to be rotated in two direction to apply hydraulic pressure to a hydraulic cylinder; and a double rod cylinder configured to provide a driving force the auxiliary axle.

The ECU calculates and controls a steering angle of the auxiliary axle in accordance with the vehicle speed and the front-wheel steering angle as in the following equations.

When a vehicle including a front-wheel first axle, a front-wheel second axle, a rear-wheel third axle, a rear-wheel fourth axle, and an auxiliary axle, in which a distance between the front-wheel first axle and a rear-wheel first axle is a first wheel base L1, a distance between the rear-wheel first axle and a rear-wheel second axle is a second wheel base L2, a distance between the rear-wheel second axle and the auxiliary axle is an auxiliary axle wheel base L3, a distance between center lines of two left and right tires of the auxiliary axis is an auxiliary axle tread L4, a center of the rear-wheel first axle and the rear-wheel second axle is a rear-axle center point G, a distance from a rotation center point to the rear-axle center point is L5, a front-wheel right steering angle is α1, and a front-wheel left steering angle is α1+α2,

1) the ECU controls a left steering angel β1+β2 of the auxiliary axle as a following equation when the vehicle speed is 30 km/h or less.

$$β 1 + β 2 = arc tan ( \frac{\frac{L 2}{2} + L 3}{L 5 - \frac{L 4}{2}} )$$

In the period of the vehicle speed is increased or decreased between 0 km/h and 30 km/h, the steering angel β1+β2 of the auxiliary axle according to variation of the front-wheel steering angles α1 and α2 is linearly changed, and variation of the auxiliary axle steering angle is almost 0 in the period in which the front-wheel steering angles are minutely changed to about ±2°.

2) the ECU controls the left steering angel β1+β2 of the auxiliary axle as a following equation when the vehicle speed is larger than 30 km/h and is equal to or less than 40 km/h.

$$β 1 + β 2 \approx ( ( - 1 / 10 ) \times Vx + 4 ) arc tan ( \frac{\frac{L 2}{2} + L 3}{L 5 - \frac{L 4}{2}} )$$

In a period in which the vehicle speed Vx is increased from 30 km/h to 40 km/h, the auxiliary axle steering angel β1+β2 according to variation of the front-wheel steering angles α1 and α2 decreases to 0.

The hydraulic auxiliary axle steering control system of the present disclosure precisely controls steering of the auxiliary axle according to steering of front wheel when a vehicle is driven at a low speed while the front wheels are steered, so it is possible to remove instability of driving, reduce wear of tires, and maximize turning in a narrow space.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a view of a hydraulic auxiliary axle steering control system;

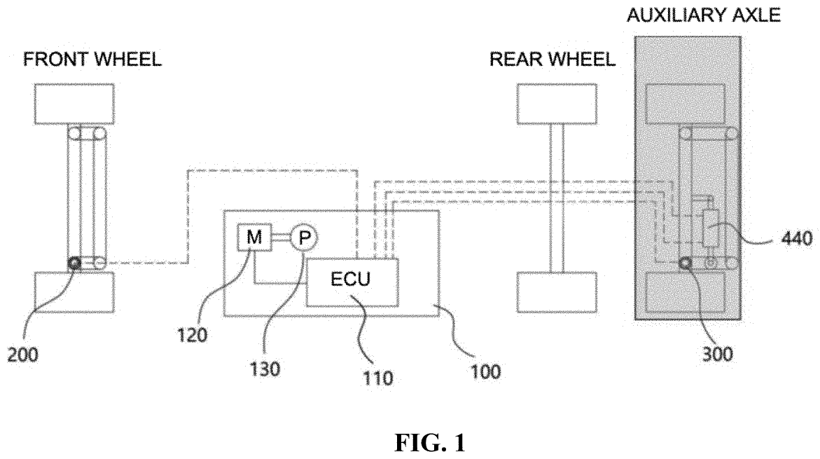

FIG. 2 is a view showing control of a front-wheel steering angle and an auxiliary axle steering angle;

FIG. 3 is a view showing an auxiliary axle steering angle result according to variation of a front-wheel steering angle;

FIG. 4 is a view showing a dead zone test result of an auxiliary axle steering angle; and

FIG. 5 is a view showing output of an auxiliary axle steering angle according to a speed.

### DETAILED DESCRIPTION OF THE INVENTION

The present disclosure may be modified in various ways and implemented by various exemplary embodiments, so that specific exemplary embodiments are shown in the drawings and will be described in detail.

However, it is to be understood that the present disclosure is not limited to the specific exemplary embodiments, but includes all modifications, equivalents, and substitutions included in the spirit and the scope of the present disclosure. Similar reference numerals are assigned to similar components in the following description of drawings.

It is to be understood that when one element is referred to as being “connected to” or “coupled to” another element, it may be connected directly to or coupled directly to another element or be connected to or coupled to another element, having the other element intervening therebetween. On the other hand, it should to be understood that when one element is referred to as being “connected directly to” or “coupled directly to” another element, it may be connected to or coupled to another element without the other element intervening therebetween.

Terms used in the present specification are used only to describe specific exemplary embodiments rather than limiting the present disclosure. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless defined otherwise, it is to be understood that all the terms used in the specification including technical and scientific terms has the same meaning as those that are understood by those who skilled in the art. It will be further understood that terms defined in dictionaries that are commonly used should be interpreted as having meanings that are consistent with their meanings in the context of the relevant art and will not be interpreted in an idealized or overly formal sense unless expressly so defined herein.

Hereinafter, exemplary embodiments of the present invention will be described with reference to the accompanying drawings.

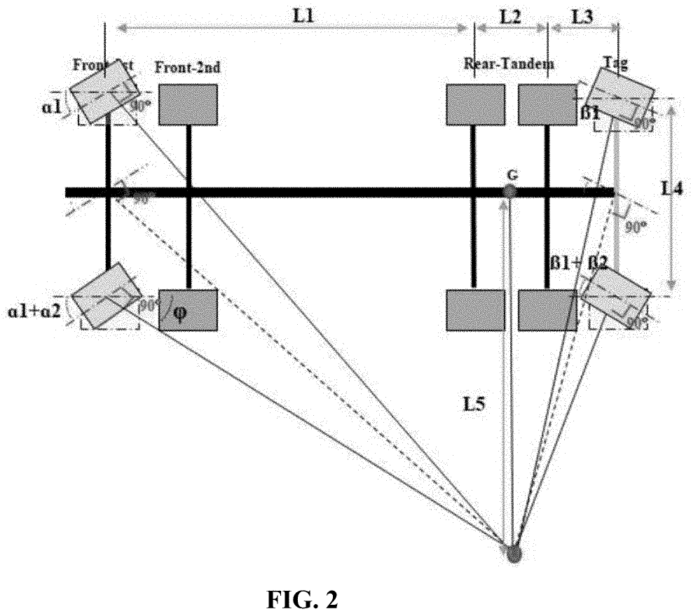

FIG. 2 is a plan view showing auxiliary axle steering angle control according to a front-wheel steering angle of a hydraulic auxiliary axle steering control system.

The embodiment of FIG. 2 is for a 4-axle freight vehicle, which includes a front-wheel first axle, a front-wheel second axle, a rear-wheel third axle, a rear-wheel fourth axle, and an auxiliary axle.

The distance between the front-wheel first axle and the rear-wheel first axle is a first wheel base L1, the distance between the rear-wheel first axle and the rear-wheel second axle is a second wheel base L2, the distance between the rear-wheel second axle and the auxiliary axle is an auxiliary axle wheel base L3, the distance between the center lines of two left and right tires of the auxiliary axis is an auxiliary axle tread L4, the center of the rear-wheel first axle and the rear-wheel second axle is a rear-axle center point G, and the distance from a rotation center point to the rear-axle center point is L5.

A front-wheel right steering angle is α1 and the front-wheel left steering angle is α1+α2.

An ECU of the auxiliary axle steering control system calculates and controls the left steering angle β1+β2 of the auxiliary axle as follows.

1) when the speed of a vehicle is 30 km/h or less (Vx≤30 km/h), the ECU controls the left steering angel β1+β2 of the auxiliary axle as the following Equation 1.

$$β 1 + β 2 = arc tan ( \frac{\frac{L 2}{2} + L 3}{L 5 - \frac{L 4}{2}} ) \qquad [ Equation 1 ]$$

wherein L2 is a second wheel base, L3 is an auxiliary axle wheel base, and L4 is an auxiliary axle tread, which are eigenvalues of the vehicle input in the ECU in advance, and L5 is calculated as the following equation 2 by the ECU on the basis of the front-wheel right steering angle α1 or the front-wheel left steering angle α1+α2.

$$\begin{matrix}L 5 = tan ( 90 ° - ( α 1 + α 2 ) ) \times ( L 1 + \frac{L 2}{2} ) + \frac{L 4}{2} \\ L 5 = tan ( 90 ° - α 1 ) \times ( L 1 + \frac{L 2}{2} ) - \frac{L 4}{2}\end{matrix} \qquad [ Equation 2 ]$$

where the front-wheel right steering angle is α1 and the front-wheel left steering angle is α1+α2 are measured by a front-wheel angle sensor mounted on a front wheel and input to the ECU, and L1, L2, and L4 are eigenvalues of the vehicle input in the ECU in advance.

In the period of the vehicle speed is increased or decreased between 0 km/h and 30 km/h, the steering angel β1+β2 of the auxiliary axle according to variation of the front-wheel steering angles α1 and α2 is linearly changed, and variation of the auxiliary axle steering angle is almost 0 in the period in which the front-wheel steering angles are minutely changed by about ±2°.

2) when the speed of a vehicle is larger than 30 km/h and equal to or smaller than 40 km/h (30 km/h<Vx<40 km/h), the ECU controls the left steering angel β1+β2 of the auxiliary axle as the following Equation 3.

$$β 1 + β 2 \approx ( ( - 1 / 10 ) \times Vx + 4 ) arc tan ( \frac{\frac{L 2}{2} + L 3}{L 5 - \frac{L 4}{2}} ) \qquad [ Equation 3 ]$$

where L2, L3, and L4 are eigenvalues of the vehicle input in advance in the ECU, and L5 is calculated as the following Equation 4 by the ECU.

$$\begin{matrix}L 5 = tan ( 90 ° - ( α 1 + α 2 ) ) \times ( L 1 + \frac{L 2}{2} ) + \frac{L 4}{2} \\ L 5 = tan ( 90 ° - α 1 ) \times ( L 1 + \frac{L 2}{2} ) - \frac{L 4}{2}\end{matrix} \qquad [ Equation 4 ]$$

When the vehicle speed is larger than 30 km/h and equal to or smaller than 40 km/h, the speed Vx is also input to the ECU and the left steering angel β1+β2 of the auxiliary axle is calculated. Further, in a period in which the vehicle speed is increased from 30 km/h to 40 km/h, the auxiliary axle steering angel β1+β2 according to variation of the front-wheel steering angles α1 and α2 decreases to 0.

3) When the vehicle speed is larger than 40 km/h (40 km/h<Vx), the steering angels β1 and β1+β2 of the auxiliary axle are 0.

That is, when the speed of the vehicle increases over 40 km/h with heavy freight thereon, a problem is generated with the driving stability of the vehicle and there is a possibility of turnover, so the steering angles of the auxiliary axle are controlled to be 0.

4) When a (front-wheel steering) direction is changed.

FIG. 2 shows the case in which the vehicle is turned left, and when the vehicle is turned right, the current left steering angle is changed to α1 from α1+α2 and the right steering angle is changed to α1+α2 from α1.

According to the present disclosure, the control relationship of the auxiliary axle steering angles β1 and β2 according to the front-wheel steering angles were optimally designed through dynamic analysis and tests of the auxiliary axle steering angles according to the front-wheel steering angles α1 and α2 at a vehicle speed of 0 km/h˜40 km/h.

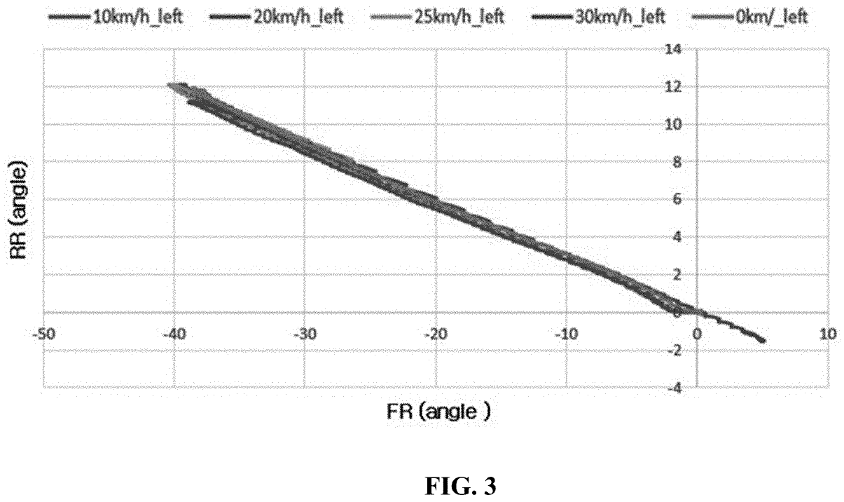

FIG. 3 shows test result data of variation of the right steering angle of the auxiliary axle according to variation of the front-wheel right steering angle when the vehicle speed is 10 km/h, 20 km/h, 25 km/h, and 30 km/h.

According to the result, when the vehicle speed is increased or decreased in the range of 0 km/h to 30 km/h, variation (12˜3) of the auxiliary axle steering angles are linear to variation (−40˜−10) of the front-wheel steering angles.

That is, when steering angle control is performed in accordance with the above equations while the vehicle speed changes between 0 km/h and 30 km/h, the variation of the auxiliary axle steering angles according to the variation of the front-wheel steering angles can be considered as being stable.

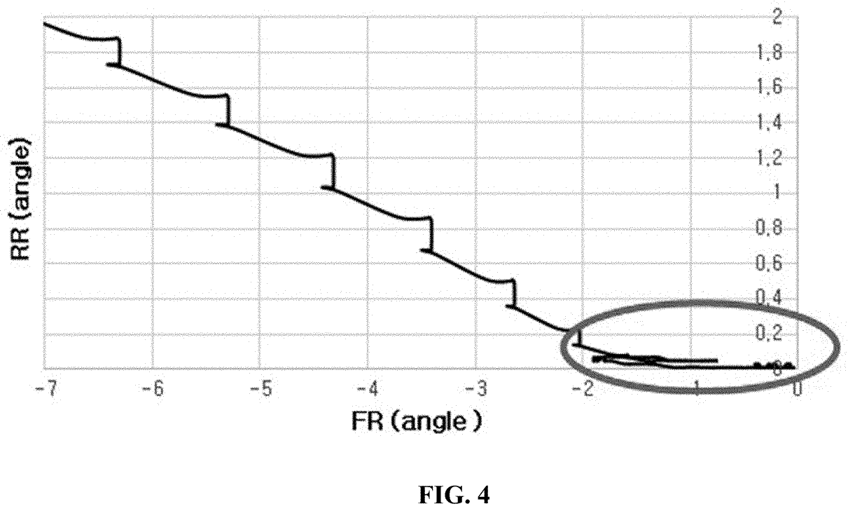

FIG. 4 shows the result of an auxiliary axle steering angle test according to the front-wheel steering angles when the vehicle speed is 30 km/h. According to the result, it can be seen that the auxiliary axle steering angles are not changed while the front-wheel steering angles are minutely changed by about ±2°.

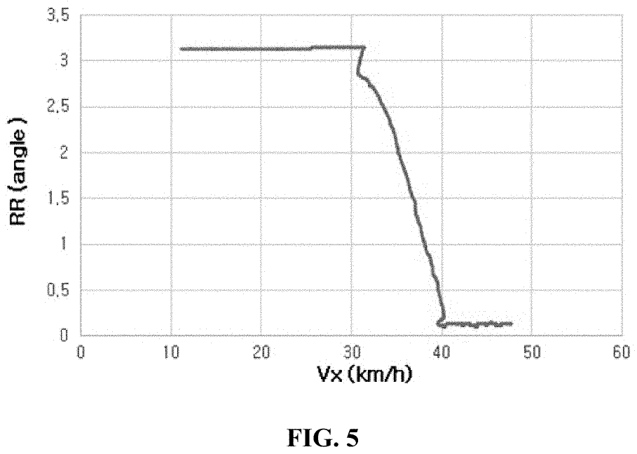

FIG. 5 shows a test result of an auxiliary axle steering angle according to a speed. It was found that the auxiliary axle steering angle is maintained at a predetermined level when the vehicle speed is 0 km/h˜30 km/h, and then the auxiliary axle steering angle decreases to 0 when the vehicle speed increases to 30 km/h˜40 km/h. That is, it can be seen that an equation wad derived such that the auxiliary axle steering angle decreases to a stable level when the vehicle speed is changed to 30 km/h˜40 km/h.

What is claimed is:

1. A hydraulic auxiliary axle steering control system, comprising:
a sensor configured to steering of front wheels and a vehicle speed;
an ECU configured to calculate and control a steering value of the auxiliary axle in accordance with the vehicle speed and steering of the front wheels;
a motor and a hydraulic pump being able to be rotated in two directions to apply hydraulic pressure to a hydraulic cylinder; and
a double rod cylinder configured to provide a driving force the auxiliary axle,
wherein the ECU calculates and controls an auxiliary axle steering angle to linearly change in accordance with variation of a front-wheel steering angle when the vehicle speed is 30 km/h or less, and
the ECU calculates and control the auxiliary axle steering angle to decrease to 0 in accordance with variation of the front-wheel steering angle in a period in which the vehicle speed increases from 30 km/h to 40 km/h, so it is possible to remove instability of driving, reduce wear of tires, and maximize turning in a narrow space by precisely controlling auxiliary axle steering according to front-wheel steering when the vehicle is driven at a low speed.

2. The hydraulic auxiliary axle steering control system of claim 1, wherein when the vehicle including a front-wheel first axle, a front-wheel second axle, a rear-wheel third axle, a rear-wheel fourth axle, and an auxiliary axle is turned left, in which a distance between the front-wheel first axle and a rear-wheel first axle is a first wheel base L1, a distance between the rear-wheel first axle and a rear-wheel second axle is a second wheel base L2, a distance between the rear-wheel second axle and the auxiliary axle is an auxiliary axle wheel base L3, a distance between center lines of two left and right tires of the auxiliary axis is an auxiliary axle tread L4, a center of the rear-wheel first axle and the rear-wheel second axle is a rear-axle center point G, a distance from a rotation center point to the rear-axle center point is L5, a front-wheel right steering angle is α1, and a front-wheel left steering angle is α1+α2,
the ECU controls a left steering angel β1+β2 of the auxiliary axle as a following equation when the vehicle speed is 30 km/h or less
$$β 1 + β 2 = arc tan ( \frac{\frac{L 2}{2} + L 3}{L 5 - \frac{L 4}{2}} )$$
and
the ECU controls the left steering angel β1+β2 of the auxiliary axle as a following equation when the vehicle speed is larger than 30 km/h and is equal to or less than 40 km/h.
$$β 1 + β 2 \approx ( ( - 1 / 10 ) \times Vx + 4 ) arc tan ( \frac{\frac{L 2}{2} + L 3}{L 5 - \frac{L 4}{2}} )$$

3. The hydraulic auxiliary axle steering control system of claim 2, wherein the L5 is calculated as following equations by the ECU on the basis of the front-wheel right steering angle α1 and the front-wheel left steering angle is α1+α.
$$\begin{matrix}L 5 = tan ( 90 ° - ( α 1 + α 2 ) ) \times ( L 1 + \frac{L 2}{2} ) + \frac{L 4}{2} \\ L 5 = tan ( 90 ° - α 1 ) \times ( L 1 + \frac{L 2}{2} ) - \frac{L 4}{2}\end{matrix}$$

4. The hydraulic auxiliary axle steering control system of claim 1, wherein when the vehicle speed is 30 km/h or less, the ECU controls the auxiliary axle steering angel to 0 without a change in a period in which the front-wheel steering angle is minutely changed by up to ±2.

5. The hydraulic auxiliary axle steering control system of claim 2, wherein when the vehicle is turned right, the ECU calculates the auxiliary axle steering angle by changing a left steering angle from α1+α2 to α1 and changing a right steering angle from α1 to α1+α2.
